(19) United States
(12) Patent Application Publication
(10) Pub. No.: US 2017/0132813 A1
(43) Pub. Date: May 11, 2017

(54) METHOD OF AND SYSTEM FOR STORING DATA FOR RENDERING GRAPHICAL OBJECTS

(71) Applicant: YANDEX EUROPE AG, Luzern (CH)

(72) Inventors: Anton Vasilyevich KORZUNOV, Moscow region (RU); Roman Borisovich TOKAREV, Moscow (RU)

(21) Appl. No.: 15/331,993

(22) Filed: Oct. 24, 2016

(30) Foreign Application Priority Data
Nov. 6, 2015 (RU) 2015147729

(51) Int. Cl. G06T 11/20; G06T 1/20

(52) U.S. Cl. CPC G06T 11/203; G06T 1/20

(57) ABSTRACT

A method of and a computing device for storing data for rendering a graphical object, the graphical object having non-monotonous border defined by conventional coordinates, the method comprising: generating the border of the graphical object; applying to the border of the graphical object, at predetermined intervals traversing elements traversing the border of the graphical object in intersection points under the same traversing angle; measuring angles between traversing elements; responsive to at least one angle between two particular traversing elements exceeding a predetermined threshold, splitting the border into border fragments; generating base lines for each generated border fragment; projecting at predetermined heights pace heights from each of the plurality of border fragments to their respective base lines; calculating heights values; storing data for rendering the border fragments as ensemble of: plurality of base line coordinates, a heights pace, and a sequence of heights values in association with a respective base line.

### CROSS-REFERENCE

The present application claims priority to Russian Patent Application No. 2015147729, filed Nov. 6, 2015, entitled “METHOD OF AND SYSTEM FOR STORING DATA FOR RENDERING GRAPHICAL OBJECTS”, the entirety of which is incorporated herein by reference.

### FIELD OF THE TECHNOLOGY

The present technology relates to method and system for storing data for rendering graphical objects.

### BACKGROUND

In computer technologies, use of graphical objects is widespread. Graphical objects are used in graphic design, in computer games, in map services, and in many other areas. Computer readable storages of computing devices (both personal devices and other devices, such as servers of service providers) can store information representative of a plurality of graphical objects, which information can be used to generate a visual representation of the graphical objects. The information representative of a plurality of graphical objects can comprise conventional coordinates of graphical objects. Conventional coordinates enable location of graphical objects in the space by choosing a set of numbers or letters specifying a particular position in the space. The coordinates are often chosen such that one of the numbers represents vertical position, and two or three of the numbers represent horizontal position. A common choice of coordinates is latitude, longitude and elevation.

Storing coordinates of graphical objects needs substantial capacities of computer readable storages. Therefore, solving the problem of frugal storing object coordinated became a challenge. One of possible solutions is storing borders of graphical objects as heights maps. Height map technology allows storing two-dimensional objects by storing one straight line (base line) and indicating “heights” (displacenents) relative the base line, therefore defining coordinates of a curved line going along the base line.

More particularly, US patent entitled “Method for modeling and rendering complex surfaces using local height maps” (U.S. Pat. No. 6,441,816 B1) teaches a method of modeling and rendering a three-dimensional complex surface using a triangle mesh is disclosed. The method can reduce memory requirement and rendering time by using local height maps and by assigning neighborhood coordinates to any point on a surface near the triangle mesh assigned to that surface. Barycentric coordinates are used to identify points in a triangular polygon to work with height data in the local height map associated with that triangular polygon. The local height maps allow collision detection of a ray with the three-dimensional surface. Lipshitz constants associated with the three-dimensional surfaces are used to find a point on the next ray closest to the three-dimensional surface to jump to, making the search for such collision points efficient.

### SUMMARY

While storing borders of graphical objects by using height maps can be more memory use effective than storing borders of graphical objects as conventional coordinates, height maps storing is intended for storing monotonous objects. However, many graphical objects have non monotonous borders. Therefore, there is a need in further developing of technologies which would allow save space on computer readable storages storing information about graphical objects.

It is thus an object of the present technology to mitigate at least some of the inconveniences present in the prior art.

In one aspect, implementations of the present technology provide a computer-implemented method of storing data for rendering a graphical object. The graphical object has non-monotonous border. The border is defined by its conventional coordinates. The method comprises: (i) based on conventional coordinates, generating the border of the graphical object; (ii) applying to the border of the graphical object, at predetermined intervals, at least two traversing elements, each traversing element traversing the border of the graphical object at a respective intersection point under the same traversing angle, the traversing angle being in the range more than zero degree and less than 180 degree; (iii) measuring plurality of angles between traversing elements and, responsive to at least one angle between two particular traversing elements exceeding a predetermined threshold, splitting the border into border fragments in points being located within a respective interval defined by these particular traversing elements in order to generate at least one monotonous border fragment; (iv) generating base lines for each generated monotonous border fragment in order to have projections to each base line from each border fragment respectively, such that each border fragment being monotonous relatively to its respective base line, and storing plurality of base line coordinates; (v) projecting heights from each monotonous border fragment to their respective base lines, projecting at predetermined heights pace, starting from a beginning of a respective monotonous border fragment and finishing at an end of a respective monotonous border fragment; (vi) calculating heights values, each height value being representative of a distance between a respective base line and a respective point on a respective monotonous border fragment, the heights values being to generate a heights maps of monotonous border fragments; (vii) storing data for rendering the monotonous border fragment as ensemble of: plurality of base line coordinates, and a heights pace, the heights pace being indicative of intervals between height projections, and a sequence of heights values in association with a respective base line.

In some implementations, steps of (i) measuring plurality of angles between traversing elements and of (ii) splitting the border into border fragments, are performed sequentially and repetitively, before generating base lines for border fragments.

In some implementations, the graphical object is a two-dimensional graphical object.

In some implementations, generating the border of the graphical object is generating a line.

In some implementations, applying to the border of the graphical object at least two traversing elements is applying at least two traversing lines.

In some implementations, generating the base line is executed by drawing two parallel lines such that one of two parallel lines crosses the beginning of the border fragment, another parallel line crosses the end of the border fragment, and the base line is generated as an interval connecting these two parallel lines and being perpendicular to both these parallel lines.

In some implementations, the two traversing elements, in the step of the splitting the border into border fragments, are consecutive traversing elements, and the method further comprises splitting said border fragments into smaller fragments until each angle between each two non-consecutive traversing elements within a respective smaller fragment is less than the predetermined threshold.

In some implementations, the heights values are selected from: positive values, zero value, negative values.

In some implementations, each traversing angle between each traversing element and the border of the graphical object in each respective intersection point is 90 degree.

In another aspect, embodiments of the present technology provide a computing device for storing data for rendering a graphical object. The graphical object has non-monotonous border defined by its conventional coordinates. The computing device comprises a processor. The computing device comprises an information storage medium. The information storage medium stores computer-readable instructions that, when executed by the processor, cause the processor to: (i) based on conventional coordinates, generate the border of the graphical object; (ii) apply to the border of the graphical object, at predetermined intervals, at least two traversing elements, each traversing element traversing the border of the graphical object at a respective intersection point under the same traversing angle, the traversing angle being in the range more than zero degree and less than 180 degree; (iii) measure plurality of angles between traversing elements and, responsive to at least one angle between two particular traversing elements exceeding a predetermined threshold, split the border into border fragments in points being located within a respective interval defined by the particular traversing elements in order to generate at least one monotonous border fragment; (iv) generate base lines for each generated monotonous border fragment in order to have projections to each base line from each border fragment respectively, such that each border fragment being monotonous relatively to its respective base line, and storing plurality of base line coordinates; (v) project at predetermined heights pace heights from each of monotonous border fragment to their respective base lines, projecting, starting from a beginning of a respective monotonous border fragment and finishing at an end of a respective monotonous border fragment; (vi) calculating heights values, each height value being representative of a distance between a respective base line and a respective point on a respective monotonous border fragment, the heights values being to generate a heights maps of monotonous border fragments; (vii) storing data for rendering the monotonous border fragment as ensemble of: plurality of base line coordinates, and a heights pace, the heights pace being indicative of intervals between height projections, and a sequence of heights values in association with a respective base line.

In some embodiments of the computing device, steps of (i) measuring plurality of angles between traversing elements and of (ii) splitting the border into border fragments, are performed sequentially and repetitively, before generating base lines for border fragments.

In some embodiments of the computing device, the graphical object is a two-dimensional graphical object.

In some embodiments of the computing device, generating the border of the graphical object is generating a line.

In some embodiments of the computing device, applying to the border of the graphical object at least two traversing elements is applying at least two traversing lines.

In some embodiments of the computing device, generating the base line is executed by drawing two parallel lines such that one of two parallel lines crosses the beginning of the border fragment, another parallel line crosses the end of the border fragment, and the base line is generated as an interval connecting the two parallel lines and being perpendicular to both these parallel lines.

In some embodiments of the computing device, the two traversing elements, in the step of the splitting the border into border fragments, are consecutive traversing elements, and the instructions, when executed by the processor, further cause the processor to split said border fragments into smaller fragments until each angle between each two non-consecutive traversing elements within a respective smaller fragment is less than the predetermined threshold.

In some embodiments of the computing device, the heights values are selected from: positive values, zero value, negative values.

In some embodiments of the computing device, each traversing angle between each traversing element and the border of the graphical object in each respective intersection point is 90 degree.

In the context of the present specification, unless specifically provided otherwise, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless specifically provided otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless specifically provided otherwise, the word “coordinates” is meant to define the position of points, and/or lines, or the like, by suitable references. References can be, for example, numbers and/or any other symbols that are used to determine the position of a point, line (including a curve in a space of a given dimension with respect to a system of lines (axes) or other fixed references.

In the context of the present specification, unless specifically provided otherwise, the term “traversing element” is meant to include lines which traverse a border of a graphical object (a traversing line). However, in some implementations, the term “traversing element” can be implemented as other traversing element, such like a traversing plane, the traversing plane intersecting the border of the graphical object.

In the context of the present specification, unless specifically provided otherwise, the term “angle” means an angle of slope between two lines or planes, or between their imaginary extensions. In the context of the present specification, some lines can be parallel, and therefore the slope between them may be zero slope. Taken this into account, in the context of the present specification, when two lines or planes are parallel, the angle is deemed exist and to be a zero degree angle. The term “angle” includes also curvilinear angles.

In the context of the present specification, the expression “curvilinear angle” means, unless specifically provided otherwise, the angle between a line and a curve, which is defined to be the angle between the tangents at the point of intersection.

In the context of the present specification, unless specifically provided otherwise, the term “degree” means 1/360 of a turn, so one turn is 360 degree (360°).

In the context of the present specification, unless specifically provided otherwise, the expression “binary degrees”, also known as the “binary radian”, means 1/256 of a turn. The binary degree is used in computing so that an angle can be efficiently represented in a single byte (albeit to limited precision).

In the context of the present specification, unless specifically provided otherwise, the expression “hour angle” means 1/24 of a turn.

In the context of the present specification, unless specifically provided otherwise, the term “grad”, also called “grade”, “gradian”, or “gon”, is 1/400 of a turn, so a right angle is 100 grads. It is a decimal subunit of a quadrant.

In the context of the present specification, unless specifically provided otherwise, the expression “information” includes information of any nature or kind whatsoever, comprising information capable of being stored in a database. Thus information includes, but is not limited to data (map data, location data, coordinates, numerical data, etc.), audiovisual works (photos, movies, sound records, presentations etc.), text (opinions, comments, questions, messages, etc.), documents, spreadsheets, etc.

In the context of the present specification, unless specifically provided otherwise, the word “component” is meant to include software (appropriate to a particular hardware context) that is both necessary and sufficient to achieve the specific function(s) being referenced.

In the context of the present specification, unless specifically provided otherwise, the expression “information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless specifically provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first original border” and “third original border” is not intended to imply any particular order, type, chronology, hierarchy or ranking (for example) of/between the original borders, nor is their use (by itself) intended imply that any “second original border” must necessarily exist in any given situation. Further, as is discussed herein in other contexts, reference to a “first” element and a “second” element does not preclude the two elements from being the same actual real-world element. Thus, for example, in some instances, a “first” element and a “second” element may be the same element, in other cases they may be different elements.

In the context of the present specification, unless specifically provided otherwise, the expression “graphical object” is intended to mean any graphical object which can be displayed on a computer screen (or other video output means). Graphical objects can be any two-dimensional objects, including linear objects. Graphical objects can be of any shape. Borders of graphical objects can be straight or curved lines, or both, depending on the graphical object.

In the context of the present specification, unless specifically provided otherwise, the term “border” is intended to mean a border of a graphical object or a fragment of the border of the graphical objectBorders can be lines (curved, straight, or both). In some implementations, a borders of a graphical object can coincide with that graphical object (for example, when the graphical object is a linear object, such as a curved or straight line).

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram of a system implemented in accordance with an embodiment of the present technology.

FIG. 2 depicts a non-limiting example of a two-dimensional graphical object, the two-dimensional graphical object being implemented in accordance with non-limiting embodiments of the present technology.

FIG. 3 depicts alternative non-limiting example of a two-dimensional graphical object, the two-dimensional graphical object being implemented in accordance with non-limiting embodiments of the present technology.

FIG. 4 illustrates a step of applying to the border of the graphical object, at predetermined intervals, plurality of traversing elements, the step of applying to the border of the graphical object the plurality of traversing elements being performed by a processor of the system of FIG. 1 in accordance with non-limiting embodiments of the present technology.

FIG. 5 illustrates angles between traversing elements, the traversing elements being applied to the border of the graphical object by the processor of the system of FIG. 1 in accordance with non-limiting embodiments of the present technology.

FIG. 6 illustrates generating, by the processor of the system of FIG. 1, base lines for border fragments, base lines being generated in accordance with non-limiting embodiments of the present technology.

FIG. 7 depicts a non-limiting example of heights being projected at a predetermined interval to a base line at the angle of 90 degree, the heights being projected by the processor of the system of FIG. 1 in accordance with non-limiting embodiments of the present technology.

FIG. 8 illustrates a step of calculating height values, the step of calculating height values being performed by the processor of the system of FIG. 1 in accordance with non-limiting embodiments of the present technology.

FIG. 9 illustrates an alternative positioning of a base line in respect to a border fragment, the alternative positioning of the base line in respect to the border fragment being performed by the processor of the system of FIG. 1 in accordance with non-limiting embodiments of the present technology.

FIG. 10 is alternative illustration of a step of calculating height values with respect to the base line of FIG. 9, the step of calculating height values being performed by the processor of the system of FIG. 1 in accordance with non-limiting embodiments of the present technology.

FIG. 11 depicts a block-diagram of a method for storing data for rendering a graphical object of FIG. 2, the graphical object having non-monotonous border defined by its conventional coordinates, the method being non-limiting example of the present technology.

### DETAILED DESCRIPTION

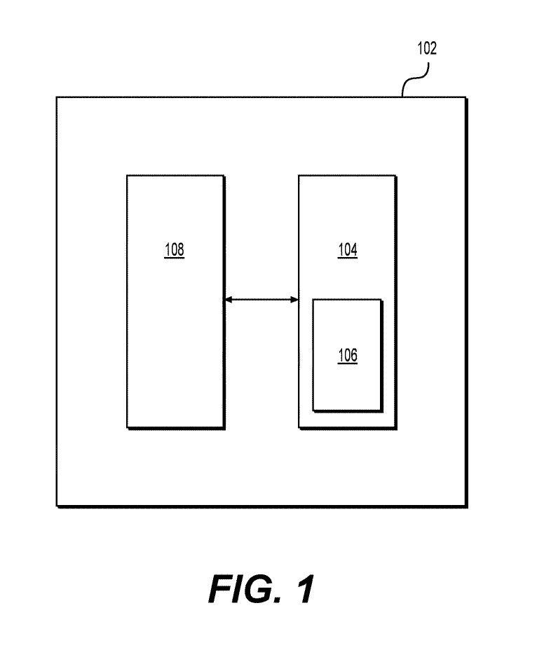

Referring to FIG. 1, there is shown a diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

System 100 includes a computing device 102 being a server 102. The server 102 may be implemented as a conventional computer server. In an example of an embodiment of the present technology, the server 102 may be implemented as a Dell™ PowerEdge™ Server running the Microsoft™ Windows Server™ operating system. Needless to say, the server 102 may be implemented in any other suitable hardware and/or software and/or firmware or a combination thereof. In the depicted non-limiting embodiment of present technology, the server 102 is a single server. In alternative non-limiting embodiments of the present technology, the functionality of the server 102 may be distributed and may be implemented via multiple servers.

In some implementations of the present technology, the server 102 can be under control and/or management of a map service provider, for example, provider of Maps.Yandex™. In alternative implementations the server 102 can access the map service provided by a third-party provider. In yet other implementations, the server 102 can be under control and/or management of provider of such services as computer game services, graphical design services, and other services related to computer graphics.

The server 102 includes an information storage medium 104 that may be used by the server 102. Generally, the information storage medium 104 may be implemented as a medium of any nature and kind whatsoever, including RAM, ROM, disks (CD-ROMs, DVDs, floppy disks, hard drivers, etc.), USB keys, solid state-drives, tape drives, etc. and also the combinations thereof.

The implementations of the server 102 are well known in the art. So, suffice it to state, that the server 102 comprises inter alia a network communication interface (such as a modem, a network card and the like) for two-way communication over a communication network (not depicted); and a processor 108 coupled to the network communication interface and the information storage medium 104, the processor 108 being configured to execute various routines, including those described herein below. To that end the processor 108 may have access to computer readable instructions stored on the information storage medium 104, which instructions, when executed, cause the processor 108 to execute the various routines described herein.

In some non-limiting embodiments of the present technology, the communication network can be implemented as the Internet. In other embodiments of the present technology, the communication network can be implemented differently, such as any wide-area communication network, local-area communication network, a private communication network and so on.

The information storage medium 104 is configured to store data, including computer-readable instructions and other data, including graphical objects data of any kind. In some implementations of the present technology, the information storage medium 104 can store at least part of the data in a database 106. In other implementations of the present technology, the information storage medium 104 can store at least part of the data in any collections of data other than databases.

Data stored on the information storage medium 104 (and more particularly, at least in part, in some implementations, in the database 106) can comprise conventional coordinates for rendering graphical objects of any kind.

Graphical objects can be two-dimensional objects of any type. Two-dimensional objects can be two-dimensional linear objects (a line, for example) and two-dimensional spatial objects (a triangle, for example).

Borders of graphical objects determine their contours. Borders of linear objects, such as lines, coincide with these objects. In other words, a linear graphical object has the same coordinates as its border. Borders of two-dimensional spatial objects can be straight lines and/or curved lines. Curved lines can be of regular geometric form (for example, a ring, an ellipse, a square) and/or irregular geometric form.

Borders of graphical objects can be defined by conventional coordinates. An example of a conventional system of coordinates is a Cartesian coordinate system.

The graphical objects can be monotonous or non monotonous. A two-dimensional graphical object is considered to be monotonous with respect to a straight line (a base line), if every line orthogonal to the base line intersects the border of the graphical object only once. A two-dimensional graphical object is called non monotonous with respect to a straight line (a base line), if at least one line orthogonal to the base line intersects the border of the graphical object at least twice.

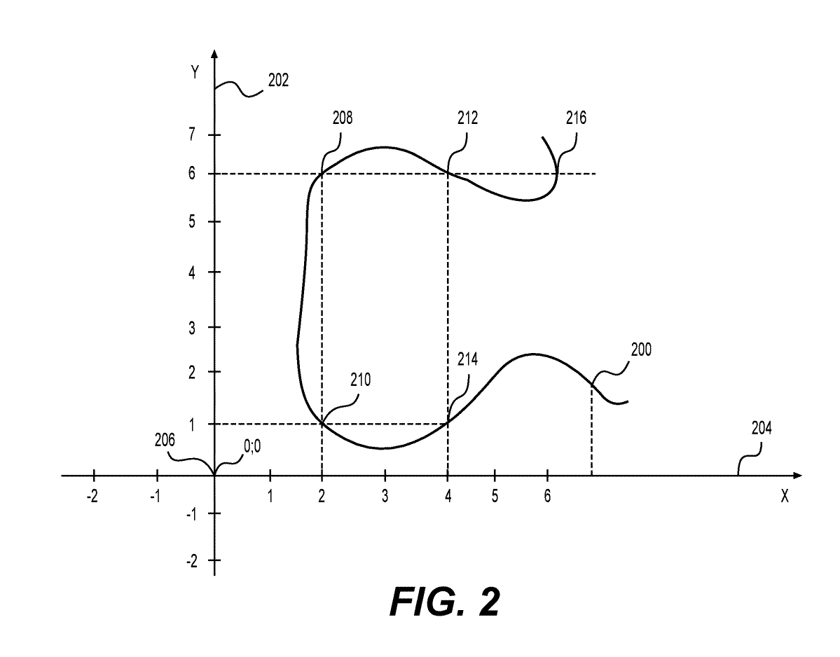

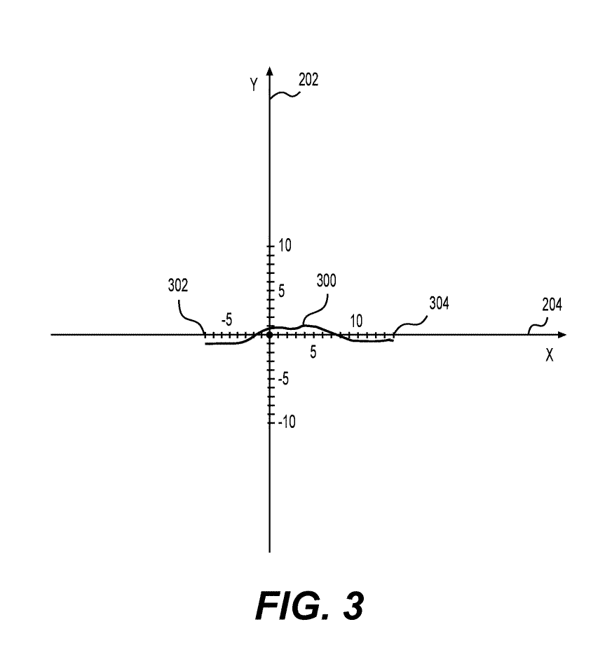

Non-limiting examples of graphical objects are depicted in FIG. 2, FIG. 3.

FIG. 2 illustrates a non-limiting example of a graphical object 200. The graphical object 200 is a two-dimensional linear graphical object being a curved line. Coordinates of borders of the graphical object 200 can be defined based on the Cartesian coordinate system. The Cartesian coordinate system is a coordinate system that specifies each point in a plane by a pair of numerical coordinates, which are the signed distances from the point to two fixed perpendicular directed lines, a Y axis 202 and an X axis 204, measured in the same unit of length. The term the signed distances means that every non-zero real number can be either positive or negative. Axes 202, 204 is called a coordinate axes or just axes of the system, and the point 206 where they meet is its origin, usually at ordered pair (0;0). The coordinates can also be defined as the positions of the perpendicular projections of the point onto the two axes, expressed as signed distances from the origin. For example, coordinates of a point 208 are (2;6), coordinates of a point 210 are (2;1), coordinates of a point 212 are (4;6), coordinates of a point 214 are (4;1), and coordinates of a point 216 are (6;6).

The graphical object 200 is non monotonous with respect to the X axis 204 (a base line), as not every line orthogonal to the axe X (204) intersects the border of the graphical object 200 only once. As one can see in FIG. 2, an orthogonal line projected to the X axis 204 from the point 208 intersects the border of the graphical object 200 in two points 208 and 210. Similarly, many lines being projected to the X axis 204 from the points being left and right of the point 208 intersect the border of the graphical object 200 in two points. Moreover, some lines being projected to the X axis 204 from the points being right the point 208 intersect the border of the graphical object 200 in three points (not depicted).

The graphical object 200 is non monotonous with respect to the Y axis 202 (a base line) either, as not every line orthogonal to the Y axis 202 intersects the border of the graphical object 200 only once. As one can see in FIG. 2, an orthogonal line projected to the Y axis 202 from the point 216 intersects the border of the graphical object 200 in three points 216, 212 and 208. Similarly, some other lines being projected to the Y axis 202 from the border of the graphical object 200 intersect the border of the graphical object 200 in two or three points.

FIG. 3 illustrates a non-limiting example of a graphical object 300. The graphical object 300 is also a two-dimensional linear graphical object being a curved line. Coordinates of the graphical object 300 can be defined based on conventional coordinates. The graphical object 300 is a line connecting points having following coordinates: (−8;−1), (−7;−1), (−6;−1), (−5;−1), (−4;−1), (−3;−0.5), (−2;0), (−1;0.5), (0;1), (2;1), (3;1.75), (4;2.2), (5;2), (6;1.75), (7;0.2), (8;0), (9;−0.3); (10;0.8), (11;0.8), (12;0.8), (13;0.8), (14;0.8). The graphical object 300 is monotonous with respect to a base line, which is in this example a straight line connecting points 302 and 304, as each line orthogonal to the straight line connecting two points 302 and 304 intersects the border of the graphical object 200 only once. In this example, the base line extends along a portion of the X axis 204. The base line itself can have conventional coordinates defining a length and a position of the base line in the two-dimensional space. In alternative implementations, the base line can extend in any direction (such as along the Y axis 202, for example), and can be located in any part of the two-dimensional space.

A graphical object can be monotonous with respect to one base line, and non-monotonous with respect to another line. For example, the graphical object 300 is non monotonous with respect to the Y axis 202, as some lines orthogonal to the Y axis 202 intersect the border of the graphical object 300 twice. For example, one line being orthogonal to the Y axis 202 will cross the border of the first graphical object 300 in two points having coordinates (−2;0) and (8;0).

The information storage medium 104 can store computer-readable instructions that, when executed, cause the processor 108 to retrieve conventional coordinates of a graphical object and, based on those coordinates, to generate the border of the graphical object. For example, the processor 108 can retrieve conventional coordinates of the graphical object 200 and, based on coordinates, generate the border of the graphical object 200, as depicted in FIG. 2.

The information storage medium 104 can store computer-readable instructions that, when executed, cause the processor 108 to apply to the border of the graphical object, at predetermined intervals, at least two traversing elements, each traversing element traversing the border of the graphical object at a respective intersection point under the same traversing angle, the traversing angle being in the range between zero degree and 180 degrees. The processor 108 can define an interval between traversing elements taking into consideration one or several factors, such like the length of the border of a respective graphical element, the nature of graphical object and others. For example, interval between traversing elements can be defined depending on the length of the border of a respective graphical element such that the longer the border is, the higher the number of traversing elements used). The interval between traversing elements can be equal, for example, to the 1/400 of the length of the respective border of the respective object. As another non-limiting example, the number of traversing elements can be an inverse ratio to computation capacity of the processor 108. As another non-limiting factor which can be taken into consideration is the nature of graphical object (one frequency of traversing elements for a general map service, and smaller frequency of traversing elements for a cadastral plans service, where shapes of land plots are usually less curved and tend to be mostly straight lines).

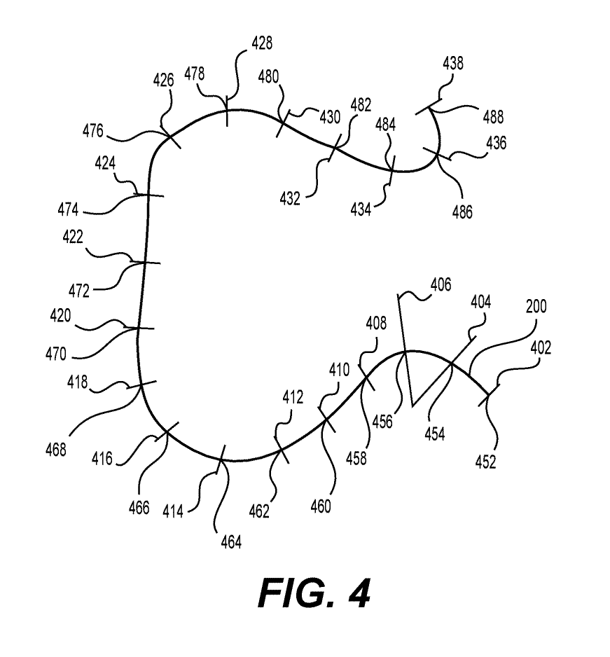

As depicted in FIG. 4, the processor 108 can apply to the border of the graphical object 200 of FIG. 2, at predetermined intervals of 4 pixels, 19 traversing elements (402, 406, 408, 410, 412, 414, 416, 418, 420, 422, 424, 426, 428, 430, 432, 434, 436, and 438) being traversing lines, each traversing element 402-438 traversing the border of the graphical object 200 at a respective intersection point (points 452, 454, 456, 458, 460, 462, 464, 464, 466, 468, 470, 472, 474, 476, 478,480, 482, 484, 486, and 488) under the same traversing angle to the border line in each intersection point. In this example, the traversing angle is the same and is 90 degree, i.e. perpendicular to the border in each point. The traversing angle is predetermined.

The person skilled in the art will understand that traversing angle does not have to be necessarily 90 degree. In other implementations, all traversing elements can traverse the border of a graphical object at other angle, for example, at 68 degree. In yet other implementations, all traversing elements can traverse the border of a graphical object at any other degree exceeding 0 degree and being less that 180 degree (for example, at 33 degree).

The information storage medium 104 can store computer-readable instructions that, when executed, cause the processor 108 to measure at least one angle between at least two traversing elements. For example, in some implementations, the processor 108 can measure all angles between each two consecutive traversing element, i.e. between respective pairs of traversing elements 402 and 404, 404 and 406, 406 and 408, and so on, finishing by measuring angles between traversing elements 336 and 338.

The angles between traversing element can vary, due to the fact that each traversing element traverses the border of the graphical object 200 at the same angle (for example, at 90 degree), but the border itself is curving. As a consequence, the angle is very sharp in the case were the border curves slightly, and the angle becomes larger in areas where the border curves more steeply. In plain fragments (if any) of a border, traversing elements will be parallel. Thus, if any two given traversing elements are parallel, this would provide an indication that the border fragment between these two traversing elements is a plain line (i.e that the border segments lacks curvature). A one degree angle between two traversing elements would be indicative of the border fragment between these two traversing elements curves very slightly, such that it can be hardly seen. A 90 degree angle between two traversing elements would be indicative of the border fragment between these two traversing elements turning around 90 degree.

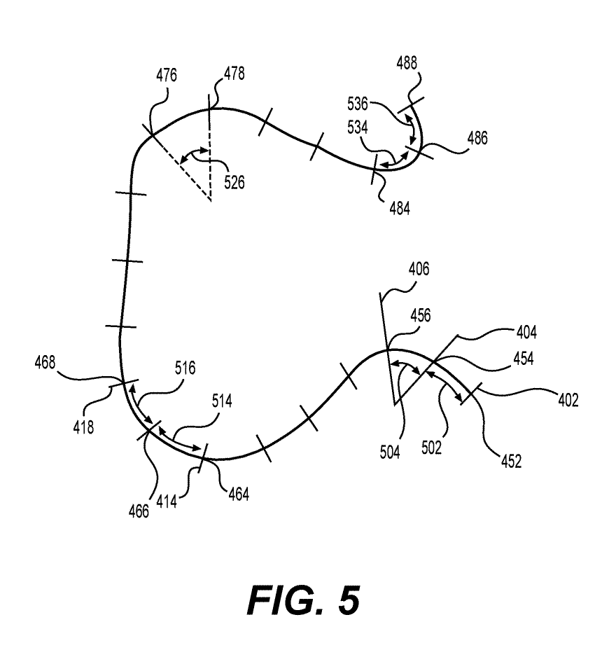

For example, referring to FIG. 5, the traversing elements 402 and 404 are parallel (if the angle 502 is zero angle) or almost parallel (if the angle 502 is slightly more than zero degrees), which is an indication that a border fragment between intersection points 452 and 454 is either a straight line (if the angle 502 between traversing elements 402 and 404 is zero), or that border fragment between intersection points 452 and 454 curves very slightly (if the angle 502 between traversing elements 402 and 404 is slightly more than zero degrees).

In contrast, angles 504, 526, 534, 536 are large, indicating that the border of the graphical object 200 turns steeply in these respective areas.

Further, angles 514 and 516 are larger than angle 502, but smaller than angles 504 and 526. The comparatively moderate degree of angle 514 indicates that the border curves moderately between intersection points 464 and 466. Likewise, the moderate size of angle 516 indicates that the border curves moderately between intersection points 466 and 468.

The processor 108 can measure angles between traversing elements. In examples above, the processor 108 measures angles in degrees. In other implementations, angles can be measured and expressed in any other suitable measure unit such as in binary degrees, in hour angles, in grads, and others.

The information storage medium 104 can store computer-readable instructions that, when executed, cause the processor 108, responsive to an angle between two traversing elements exceeding a predetermined threshold, to generate two border fragments by splitting the border into two border fragments in one of intersection points or in any other point within an interval between these two intersection points (i.e., between two respective traversing elements). Generating two border fragments by splitting the border into two border fragments happens when a graphical object 200 is a linear object (non-closed loop). In the case where graphical object is a two-dimensional object having contour border (i.e. closed loop), one splitting will generate deemed open loop, and the second splitting will generate two border fragments, each fragment being defined by the two points in the splitting area.

For example, referring to FIG. 5, the threshold can be predetermined to the effect that if an angle between any two consecutive traversing elements exceeds 45 degrees, the processor 108 can split the border 200 into two border fragments in one of intersection points within an interval between these two traversing elements. The processor 108 can determine that the angle 502 is less than 45 degree. Therefore, the processor 108 does not split the border of the graphical object 200 in any place between intersection points 452 and 454. Then, the processor 108 can determine that the angle 504 is more than 45 degree. Therefore, the processor 108 splits the border of the graphical object 200 in any place between intersection points 454 and 456, including any one of these points themselves. The choice of a specific splitting point between intersection points is not important—it can be one of respective intersection points 454 or 456, or any other point between them. For example, the processor 108 can split the border in the intersection point 456. Similarly, the processor 108 can check each consecutive angle and to determine if splitting is necessary. Thus, the processor can determine that three more angles—angles 526, 534, and 536—exceed 45 degree and therefore the border can be split in respective areas (between intersection lines creating these respective angles).

Having performed initial splitting, the processor 108 can analyse angles between non-consecutive traversing elements within each fragment. For example, the processor 108 can check the fragment from point 456 to 476, starting from point 456. After analysis of angles 514 and 515, the processor 108 can establish that the sum of angles 514 and 516 exceeds 45 degrees. In other words, the angle between traversing elements 414 and 418 exceeds 45 degree. Responsive to the angle between traversing elements 414 and 418 exceeding 45 degree, the processor 108 can split the border of the first graphical object 200 in any place between intersection points 464 and 468. Therefore substantial but gradual turn of the border can be taken into consideration while deciding of necessity of splitting a border of the graphical object 200.

Splitting the border of the graphical object 200 allows generating monotonous border fragments, due to curving parts of the border can be detected by detecting steep angles, and the border can be then separated in a number of monotonous fragments until each fragment has no traversing elements forming an angle exceeding the threshold. As a result, obtained fragments can be free from such curves which render the fragment to be non-monotonous.

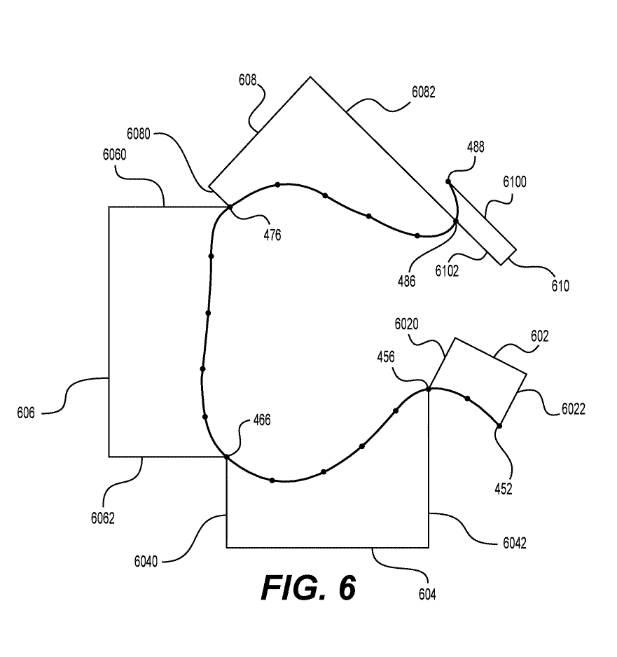

The information storage medium 104 can store computer-readable instructions that, when executed, cause the processor 108, after a monotonous border fragment being generated, to generate a base line for the monotonous border fragment. In some implementations, the computer-readable instructions can cause the processor 108 to generate plurality of base lines for plurality of monotonous border fragments. Each base line can be generated for a respective monotonous border fragment. For example, referring to FIG. 6, six base lines 602, 604, 606, 608, and 610 can be generated.

Generating base lines can be executed by drawing two parallel lines such that one of two parallel lines crosses the beginning of the monotonous border fragment, another parallel line crosses the end of the monotonous border fragment, and the base line is generated as an interval connecting the two parallel lines and being perpendicular to both parallel lines.

For example, the base line 602 can be generated by drawing a line 6020 and a line 6022, the line 6020 and the line 6022 being parallel one with respect to another one. The line 6022 crosses the beginning of the border fragment in the intersection point 452, another parallel line 6020 crosses the end of the border fragment in the intersection point 452, and the base line 602 is generated as an interval connecting these two parallel lines 6020, 6022 and being perpendicular to both parallel lines 6020, 6022.

As another example, the base line 604 can be generated by drawing a line 6040 and a line 6042, the line 6040 and the line 6042 being parallel one with respect to another one. The line 6042 crosses the beginning of the border fragment in the intersection point 456, another parallel line 6040 crosses the end of the border fragment in the intersection point 466, and the base line 604 is generated as an interval connecting two parallel lines 6040, 6042 and being perpendicular to both these parallel lines 6040, 6042.

Generating the base lines is performed in such a way to allow a projection to a base line from respective border fragment. Generating the base lines has to be performed such that border fragments are monotonous relatively to the base line, such that two parallel lines 6040 and 6042 allow to create a projection of the whole border fragment being between intersection points 456 and 466 such that each height from each possible point between points 456 and 466 would not intersect the respective border fragment. Thus, for example, it would be not possible to generate base line 604 as a vertical line to the left or to the right from the border fragment defined by points 456 and 466. To select a suitable positioning of a base line 604, the processor 108 can check whether there are at least two points within the border fragment which would have the same coordinate on X axis 204 and/or Y axis 202. If at least two points within the border fragment have the same coordinate on Y axis 202, the base 208 cannot extend along Y axis 202. Further, if at least two points within the border fragment would have the same coordinate on X axis 204, the base 208 could not extend along X axis 204. If the base line can be neither horizontal nor vertical, the base line can be generated as a line being declined in respect of axes 202 and 202.

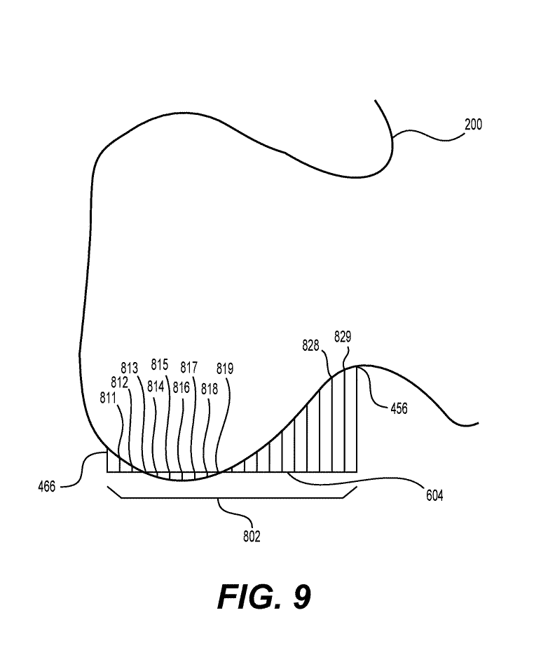

As is clearly visible in FIG. 9, points 813 and 819 have the same Y axe 202 coordinate. Thus, the base line 604 cannot extend along Y axis 202 (vertically). However, there are no point within the border fragment which would have the same X axis 204 coordinate. Therefore, the processor 108 can generate base line extending along X axis 204 (i.e., horizontally).

The information storage medium 104 can store computer-readable instructions that, when executed, cause the processor 108 to store coordinates of the generated base lines. Base line coordinates can be stored in any suitable system of coordinates.

The information storage medium 104 can store computer-readable instructions that, when executed, cause the processor 108 to project, at predetermined pace, starting from a beginning of the border fragment and finishing at an end of the border fragment, heights from the border fragment to the base line. Intervals between heights are predetermined in such way so that intervals between heights are smaller than intervals between traversing elements. For example, intervals between heights can be predetermined in such a way so that each one interval between two consecutive heights is equal to 1/10 of the interval between two consecutive traversing elements. The smaller the predetermined interval between consecutive heights is, the more accurate coordinates of a respective border portion.

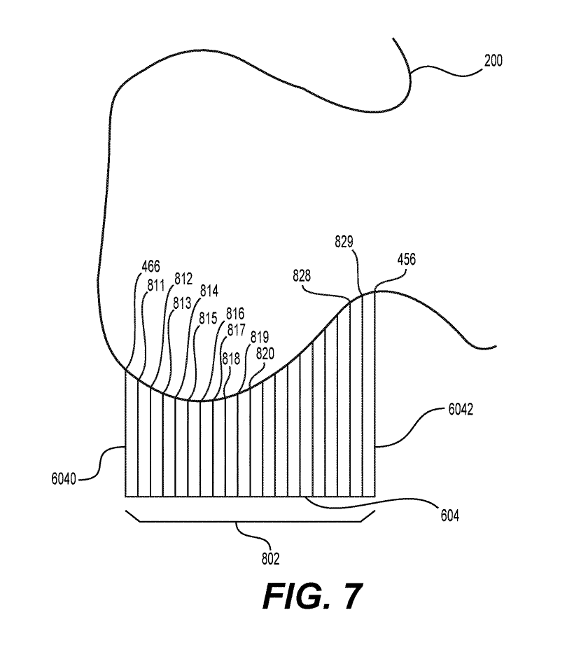

FIG. 7 depicts a non-limiting example of twenty one instances of heights 802, heights 802 being projected at a predetermined interval of 1 pixel to the base line 604 at the angle of 90 degree to the base line 604. Heights 802 are projected to the base line 602 starting from the beginning of the border fragment in the intersection point 456, then from points 811, 812, 813, 814, 815, 816, 817, 819, 820 and so on, finishing points 828, 829, and 456, the point 456 being the end of the border fragment. In this implementation, the predetermined interval defines interval between each two consecutive heights 802 projected to the same base line 604.

The expression “starting from a beginning of the border fragment and finishing at an end of the border fragment” does not mean any sequence of projecting heights. Heights can be projected in any sequence, including simultaneous projection of all or some heights. The expression “starting from a beginning of the border fragment and finishing at an end of the border fragment” is rather intended to mean limits of the projections. Thus, in the example depicted in FIG. 7, the outermost left height 802 coincides with the line 6040, the outermost right height 802 coincides with the line 6042, which lines 6040 and 6042 were previously used to generate the base line 604.

The information storage medium 104 can store computer-readable instructions that, when executed, cause the processor 108 to calculate heights values.

The heights values are distances between the base line and respective coordinates of the border fragment. The aim of the calculating is to generate a heights map of the border fragment. Referring to FIG. 7 as to a non-limiting example, the processor 108 can calculate distances between the base line 604 and following points on the border fragment: 466, 811, 812, 813, 814, 815, 816, 817, 818, 819, 820 and so on finishing in points 828, 829 and 456. These calculated distances are height values.

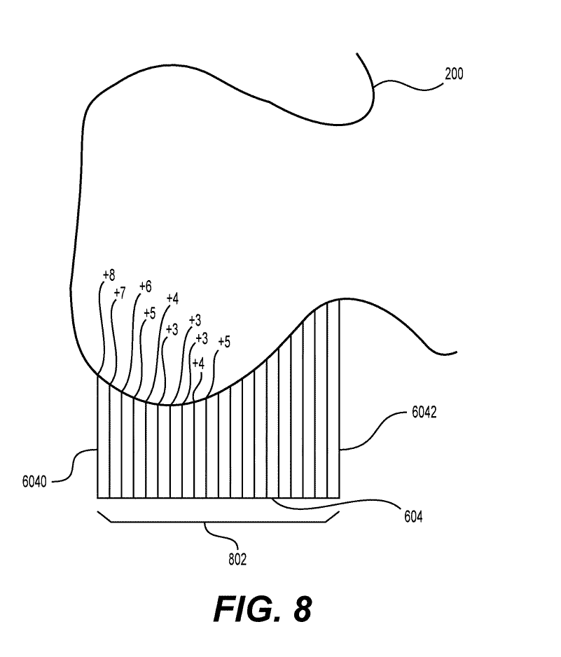

In the illustration of FIG. 6, in FIG. 7 and in FIG. 9, all points in the range from the point 466 to the point 456 are located on the same side with respect to the base line 604 (up to the base line 604). In this example, as can be seen in FIG. 8, all height values have the same sign, such as +8, +7, +6, +4, +3, +3, +3, +4 and so on.

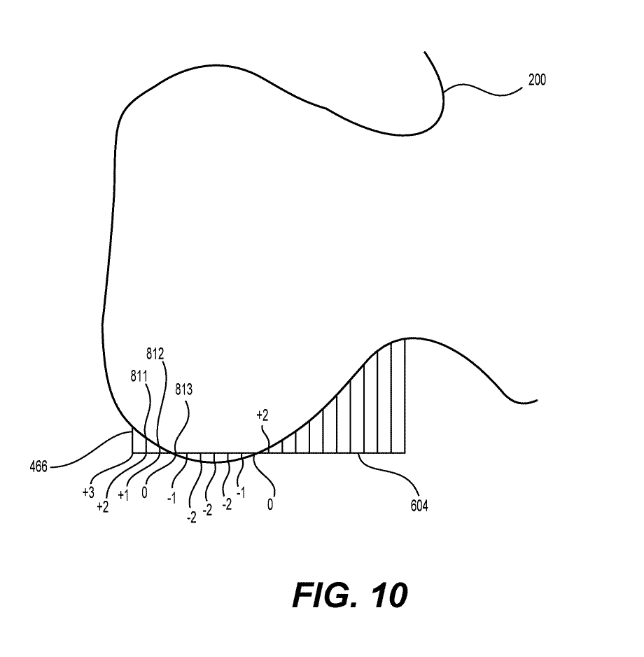

However, it is possible, in some implementations, that a base line crosses a border fragment for which that base line was generated, as was explained above with reference to FIG. 3. For better clarity, FIG. 9 depicts an alternative implementation of the base line 604, the base line 604 in this implementation crossing the border fragment for which it was generated. As a result, the heights 802 can be projected in two directions (up and down, in this example). Consequentially, as depicted in FIG. 10, the height values may have different signs, positive (such as +3, +2, +1, +2 and so on) and negative (such as −1, −2, −2, −2, and −1). Moreover, some height values can be zero values when the border fragment, the base line 604 and a height 802, all intersect in the same point (such as in points 813 and 819).

The information storage medium 104 can store computer-readable instructions that, when executed, cause the processor 108 to store data for rendering the border fragment as an ensemble of: base line coordinates, and a heights pace, the heights pace being indicative of intervals between height projections, and a sequence of heights values.

For example, the processor 108 can store coordinates of the base line 604 in the Cartesian system of coordinates. Then, the processor 108 stores the heights pace which is in this implementation, as was mentioned above, 1 pixel (which is the predetermined interval between heights). Then, the processor 108 stores the sequence of heights values, for example, from the left to right, referring to FIG. 10: +3, +2, +1, 0, −1, −2, −2, −2, −1, 0, +2, end so on, till the value of the last right side height 802.

The computing device 102 of the system 100 was described above as being the server 102. However, this is does not need to be so in every embodiment of the present technology. In alternative implementations of the present technology, the computing device 102 can alternatively be implemented as a client device 102.

The client device 102 is typically associated with a user (not depicted). It should be noted that the fact that the client device 102 is associated with the user does not need to suggest or imply any mode of operation—such as a need to log in, a need to be registered or the like.

The client device 102 can be implemented, for example, as Dell™ Precision T1700 MT CA033PT170011RUWS PC with Intel® Xeon™ processor 108, CPU frequency 3300 MHz, video card nVIDIA Quadro K2000 (not depicted), running the Windows 7® Pro 64-bit operating system, the operating system installed and active. The client device 102 comprises inter alia a network communication interface (not depicted) such as a modem, a network card and the like for two-way communication over a communication network (not depicted) with other computing devices. As those skilled in the art will understand, the implementation of the client device 102 is not particularly limited. The client device 102 may be implemented as a personal computer (desktops, laptops, netbooks, etc.), a wireless communication device (a cell phone, a smartphone, a tablet and the like), as well as other equipment.

The client device 102 can comprise a user input device (not depicted). How the user input device is implemented is not particularly limited and may depend on how the client device 102 is implemented. The user input device may include any mechanism for providing user input to the processor 108. The user input device can be a keyboard, and/or a mouse, and so on. The input device is not limited to any specific input methodology, but could be arranged by a virtual button on a touch-screen display or a physical button on the cover of the electronic device, for instance.

Merely as an example and not as a limitation, in those embodiments of the present technology where the client device 102 is implemented as a wireless communication device (such as a smartphone), user input device can be implemented as an optical interference based user input device. The user input device of one example is a finger/object movement sensing device on which a user performs a gesture and/or presses with a finger. The user input device can identify/track the gesture and/or determines a location of a user's finger on the user input device. In the instances where the user input device is executed as the optical interference based user input device, such as touch screen, or multi-touch display, the user input device can further execute functions of the display screen (not depicted).

The user input device is communicatively coupled to a processor 108 and transmits input signals (and output signals where it also operates as the display screen) based on various forms of user input for processing and analysis by processor 108.

The client device 102 further comprises an information storage medium 104, also referred to as the local memory 104. Local memory 104 can comprise any type of media, including but not limited to RAM, ROM, disks (CD-ROMs, DVDs, floppy disks, hard drivers, etc.), USB keys, solid state-drives, tape drives, etc. Generally speaking, the purpose of the local memory 104 is to store computer readable instructions as well as any other data.

The client device 102 further can comprise the display screen. Display screen can be liquid crystal display (LCD), light emitting diode (LED), Interferometric modulator display (IMOD), or any other suitable display technology. The display screen is generally configured to display a graphical user interface (GUI) that provides an easy to use visual interface between the user of the client device 102 and the operating system or application(s) running on the client device 102. Generally, the GUI presents programs, files and operational options with graphical images. Display screen is also generally configured to display other information like user data and web resources. Display screen can also be touch based devices such as touch screen. A touch screen is a display that detects the presence and location of user touch inputs. Display screen can also be dual touch or multi-touch displays that can identify the presence, location and movement of a touch inputs. In the instances where the display screen is implemented as a touch based device such as touch screen, or multi-touch display, the display screen can execute functions of the user input device.

The display screen can be communicatively coupled to processor 108 and receives signals from the processor 108. In instances where display screen is implemented as a touch based device such as touch screen, or multi-touch display, the display screen can also transmit input signals based on various forms of user input for processing and analysis by processor 108.

The client device 102 further comprises the above mentioned processor 108. The processor 108 is configured to perform various operations in accordance with a machine-readable program code. The processor 108 is operatively coupled to the user input device, to the local memory 104, and to the display screen. The processor 108 is configured to have access to computer readable instructions which instructions, when executed, cause the processor to execute the various routines. As non-limiting examples, the processor 108 described herein can have access to computer readable instructions, which instructions, when executed, can cause the processor 108 to: display information on the display screen; receive from a user of the client device 102 via the user input device a request to render graphical objects.

The local memory 104 is configured to store data, including computer-readable instructions and other data, including graphical objects data of any kind. In some implementations of the present technology, the local memory 104 can store at least part of the data in a database 106. In other implementations of the present technology, the local memory 104 can store at least part of the data in any collections of data other than databases.

Data stored on the local memory 104 (and more particularly, at least in part, in some implementations, in the database) can comprise graphical objects of any kind. Non-limiting examples of graphical objects are depicted in FIG. 2 and in FIG. 3.

The local memory 104 can store computer-readable instructions that manage control, updates, populating and modifications of the database and/or other collections of data. More specifically, computer-readable instructions stored on the local memory 104 allow the client device 102 to receive (to update) information in respect of graphical objects (for example, from input device, or via the communication network, and so on), to store information in respect of the graphical objects, including the information in respect of their respective borders in the database, and/or in other collections of data.

Computer-readable instructions, stored on the local memory 104, when executed, can cause the processor 108 to perform same functions, as computer readable instructions, stored on the computer readable storage medium 104 of the server 102.

The client device 102 can comprise inter alia a network communication interface (such as a modem, a network card and the like) for two-way connection with the communication network. The client device 102 can be coupled to the communication network, using the network communication interface, via a communication link (not numbered). In some non-limiting embodiments of the present technology, the communication network can be implemented as the Internet. In other embodiments of the present technology, the communication network can be implemented differently, such as any wide-area communications network, local-area communications network, a private communications network and the like. The client device 102 can establish connections, through the communication network, with other devices, such as servers. More particularly, the client device 102 can establish connections and interact with the server 102.

How the communication link is implemented is not particularly limited and will depend on how the client device 102 is implemented. Merely as an example and not as a limitation, in those embodiments of the present technology where the client device 102 is implemented as a wireless communication device (such as a smartphone), the communication link can be implemented as a wireless communication link (such as but not limited to, a 3G communications network link, a 4G communications network link, a Wireless Fidelity, or WiFi® for short, Bluetooth® and the like). In those examples, where the client device 102 is implemented as a notebook computer, the communication link can be either wireless (such as the Wireless Fidelity, or WiFi® for short, Bluetooth® or the like) or wired (such as an Ethernet based connection).

It should be expressly understood that implementations for the client device 102, the communication link and the communication network are provided for illustration purposes only. As such, those skilled in the art will easily appreciate other specific implementation details for the client device 102, the communication link and the communication network. As such, by no means, examples provided herein above are meant to limit the scope of the present technology.

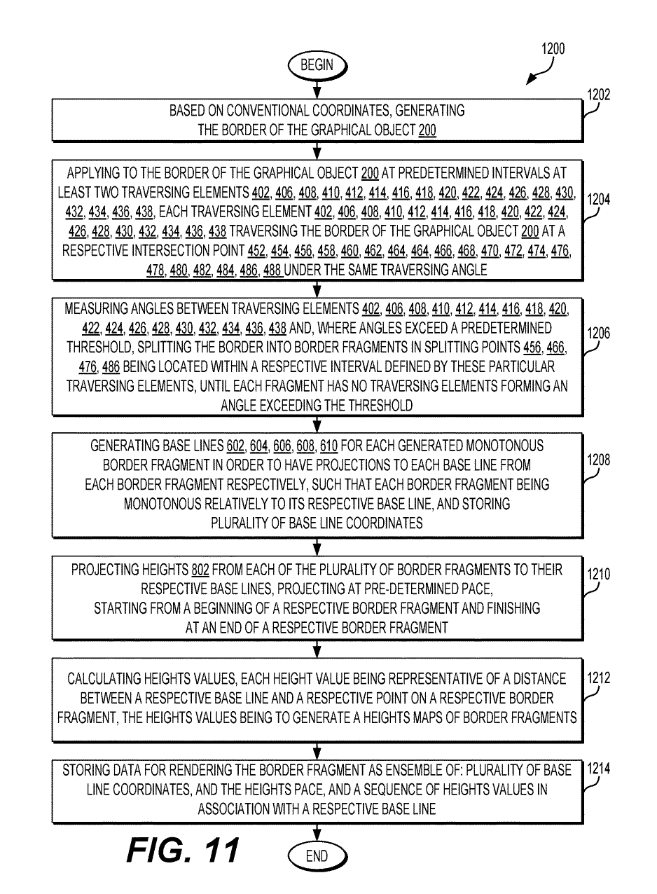

FIG. 11 illustrates a computer-implemented method 1200 of storing data for rendering a graphical object 200, the graphical object 200 having non-monotonous border defined by its conventional coordinates.

Storing graphical objects in a conventional system of coordinates, such as in the Cartesian system of coordinates, can consume substantial storage resources of computing devices.

Broadly speaking, the steps of the method 1200 contemplate separating the non-monotonous borders of graphical object 200 into monotonous border fragments. To be monotonous, a border fragment has to be relatively straight. Analysis of interposition of traversing lines allows detecting points where processor 108 can split the border into fragments in order to generate monotonous border fragments. Once monotonous border fragments are generated, the processor 108 can generate respective base lines for respective monotonous border fragments, and generate heights map for border fragments.

Step 1202—Based on Conventional Coordinates, Generating the Border of the Graphical Object 200

The method 1200 starts at step 1202, where the processor 104 retrieves from the information storage medium 104 conventional coordinates of border of the graphical object 200 and, based on the retrieved conventional coordinates, generates the border of the graphical object 200.

Then, the method 1100 proceeds to the step 1104.

Step 1204—Applying to the Border of the Graphical Object 200 at Predetermined Intervals at Least Two Traversing Elements, Each Traversing Element Traversing the Border of the Graphical Object 200 at a Respective Intersection Point Under the Same Traversing Angle

Next, at step 1204, the processor 108 applies to the border of the graphical object 200 traversing elements 402, 406, 408, 410, 412, 414, 416, 418, 420, 422, 424, 426, 428, 430, 432, 434, 436, 438 at the predetermined intervals. Traversing elements 402, 406, 408, 410, 412, 414, 416, 418, 420, 422, 424, 426, 428, 430, 432, 434, 436, 438 traverse the border of the graphical object 200 in intersection points 452, 454, 456, 458, 460, 462, 464, 464, 466, 468, 470, 472, 474, 476, 478,480, 482, 484, 486, and 488. In this implementation, the predetermined intervals are equal to 4 pixels. In other implementations, the predetermined intervals can be larger or smaller, and they can be expressed in any suitable measuring unit.

In this implementation of the present technology, traversing elements 402, 406, 408, 410, 412, 414, 416, 418, 420, 422, 424, 426, 428, 430, 432, 434, 436, 438 are traversing lines. However, in other implementations, traversing elements can be other objects, such like traversing plain surfaces.

In this implementation, each traversing line 402-438 traverses the border of the graphical object 200 at a respective intersection point 452, 454, 456, 458, 460, 462, 464, 464, 466, 468, 470, 472, 474, 476, 478,480, 482, 484, 486, and 488 under the same traversing angle being equal to 90 degree. When a respective part of the border of the graphical object 200 is a curved line, the angle between the traversing line and the border is calculated as an angle between the traversing line and an imaginary line being tangent to the border of the graphical object 200 at a respective intersection point.

In alternative implementations, traversing angles can be any angle being in the range more than zero degree and less than 180 degree, all traversing angles being the same.

Step 1206—Measuring Angles Between Traversing Elements and, Responsive to at Least One Angle Between Two Particular Traversing Elements Exceeding a Predetermined Threshold, Splitting the Border into Border Fragments in Points being Located Within a Respective Interval Defined by These Particular Traversing Elements

In this implementation, at step 1206, the processor 108 measures angles between pairs of consecutive traversing lines, starting from a pair 402-404, 404-406 and so on, finishing by a pair 436-438. In other words, processor 108 measures angles starting from the angle 502 and finishing by the angle 536.

The threshold can be predetermined to the effect that if an angle between any two traversing lines exceeds a predetermined value, such as 40 degree, for example, the processor 108 can split the border 200 into border fragments in one of splitting points within an interval between these two traversing lines. The processor 108 determines which of angles 502-536 exceeds that predetermined threshold.

For example, the processor 108 determines that there are four angles between three pairs of consecutive traversing lines (404-406, 476-478, 484-486, and 486-488) which exceed the predetermined threshold of 40 degree: the angle 456 (59 degree), the angle 476 (46 degree), the angle 534 (85 degree), and the angle 536 (70 degree). The processor 108 further determines that all other angles between pairs of consecutive traversing lines do not exceed the predetermined threshold of 40 degree.

Then, the processor 108 can split the border of the graphical object 108 in points located respectively between traversing lines 404 and 406, 476 and 478, 484 and 486, 486 and 488. The exact position of the splitting point within the interval is not important. In this implementation, splitting points will coincide with some intersection points. In this implementation of the present technology, the processor 108 splits the border as follows: in the point 456, in the point 476, in the point 486 (for both angles 534 and 536). In other implementation, splitting points do not have to coincide with intersection points. Splitting points can be anywhere between splitting points, including the intersection points themselves.

As a result, four border fragments are generated: between points 452 and 456, 456 and 476, 476 and 486, 486 and 488.

Then, in this implementation, the processor 108 measures, within each border fragment, angles between pairs of non-consecutive traversing lines in order to establish whether there are angles exceeding the predetermined threshold of 40 degree. The processor 108 can determine sum of angles 514 and 516 exceeds 40 degree (in other words, the angle between traversing lines 414 and 418 exceeds the predetermined threshold of 40 degree). Responsive to that, the processor 108 can split the border fragment (a line connecting points 456 to 476) into two border fragments in any point between two respective non-consecutive traversing lines.

As a result, five border fragments will be generated: between points 452 and 456, 456 and 466, 466 and 476, 476 and 486, 486 and 488.

Summing up, steps of measuring plurality of angles between traversing elements and of splitting the border into border fragments, are performed in this implementation sequentially and repetitively: (i) measuring angles between consecutive traversing elements; (ii) splitting the border into fragments; (ii) measuring angles between non-consecutive traversing elements within fragments of the border; (ii) splitting the border (fragments) into further fragments until obtaining monotonous fragments. All measuring and all splitting are performed, in this technology, before generating base liens for respective border fragments.

Then, the method 1200 proceeds to the step 1208.

Step 1208—Generating Base Lines for Each Generated Monotonous Border Fragment in Order to have Projections to Each Base Line from Each Border Fragment Respectively, such that Each Border Fragment being Monotonous Relatively to its Respective Base Line, and Storing Plurality of Base Line Coordinates

At step 1208, the processor 108 generates, for all five border fragments defined by points 452 and 456, 456 and 466, 466 and 476, 476 and 486, 486 and 488 five respective base lines 602, 604, 606, 608, and 610. Generating of base lines was explained above with references to FIG. 6 i.e. for all monotonous segments.

Then, the method proceeds to the step 1210.

Step 1210—Projecting Heights from Each of the Plurality of Border Fragments to Their Respective Base Lines, Projecting at Predetermined Pace, Starting from a Beginning of a Respective Border Fragment and Finishing at an End of a Respective Border Fragment

At step 1210, the processor 108 projects heights from each of the plurality of border fragments to their respective base lines, projecting at predetermined pace, starting from a beginning of a respective border fragment and finishing at an end of a respective border fragment. Projecting heights was explained above in respect to the border fragment defined by points 456 and 466 with references to FIG. 7. Projecting heights from other border fragments to their respective base lines can be performed in the same way.

In this implementation, predetermined pace between heights is the same, without regard to which base line heights are projected.

Then, the method 1200 proceeds to step 1212.

Step 1212—Calculating Heights Values, Each Height Value being Representative of a Distance Between a Respective Base Line and a Respective Point on a Respective Border Fragment, the Heights Values being to Generate a Heights Maps of Border Fragments

At step 1212, the processor calculates heights values, each height value being representative of a distance between a respective base line and a respective point on a respective border fragment, the heights values to be used for generating heights maps of border fragments. The process of calculating heights values with regard to heights projected to the base line 604 was explained above with references to FIG. 8. Similarly, processor 108 calculates heights values of heights projected to each base line (602, 604, 606, 608, 610).

Step 1214—Storing Data for Rendering the Border Fragment as Ensemble of: Plurality of Base Line Coordinates, and a Heights Pace, the Heights Pace being Indicative of Intervals Between Height Projections, and a Sequence of Heights Values in Association with a Respective Base Line

At step 1214, the processor 108 stores on the information storage medium 104, separately with regard to each border fragment: coordinates of a respective base line, heights pace, and the sequence of heights values in association with a respective base line.

For example, the processor 108 can store on the information storage medium 104 conventional coordinates of the base line 604, heights pace determining interval between each two heights 802, and the sequence of heights values (8, +7, +6, +4, +3, +3, +3, +4 and so on, as depicted in FIG. 8). Heights values are associated with the base line 604. All this data can be then used once there is a need in generating the border fragment located between points 456 and 466 by using height map instead of conventional coordinates.

Similarly, the processor 108 can store on the information storage medium 104, separately, coordinates of each base line, heights pace, and the sequence of heights values in association with a respective base line. All this data can be then used once there is a need in generating the border of the graphical object 200 by using height maps instead of conventional coordinates for generating a sequence of border fragments, which all together can render complete border of the graphical object 200.

After generating height maps for each border fragment of the graphical object 200, the processor 108 can delete conventional coordinates of the graphical object 200.

Then, the Method 1200 Ends

Practical industrial application of described technology can consist in sparing storing capacities of information storage mediums of computing devices, since storing borders of graphical objects as sequences of height maps can be less resource consuming than storing borders of graphical objects in some conventional systems of coordinates.

Steps of the method 1200 were explained as they can be executed on the computing device 102 being the server 102 of the system 100. However, steps of the method 1200 can be executed on the computing device 102 being a client device 102 of the system 100.

From a certain perspective, embodiments of the present technology can be summarized as follows, structured in numbered clauses:

Clause 1. A computer-implemented method of storing data for rendering a graphical object (200), the graphical object (200) having a border being non-monotonous and being defined by conventional coordinates, the method comprising:
(i) based on the conventional coordinates, generating the border of the graphical object (200);
(ii) applying to the border of the graphical object (200), at predetermined intervals, at least two traversing elements (402, 406, 408, 410, 412, 414, 416, 418, 420, 422, 424, 426, 428, 430, 432, 434, 436, 438), each traversing element (402, 406, 408, 410, 412, 414, 416, 418, 420, 422, 424, 426, 428, 430, 432, 434, 436, 438) traversing the border of the graphical object (200) at a respective intersection point (452, 454, 456, 458, 460, 462, 464, 464, 466, 468, 470, 472, 474, 476, 478,480, 482, 484, 486, 488) under a same traversing angle;
(iii) measuring plurality of angles between traversing elements (402, 406, 408, 410, 412, 414, 416, 418, 420, 422, 424, 426, 428, 430, 432, 434, 436, 438) and, responsive to at least one angle of the plurality of angles between two particular traversing elements (402, 406, 408, 410, 412, 414, 416, 418, 420, 422, 424, 426, 428, 430, 432, 434, 436, 438) exceeding a predetermined threshold, splitting the border into border fragments in points (456, 466, 476, 486) being located within a respective interval defined by these particular traversing elements (402, 406, 408, 410, 412, 414, 416, 418, 420, 422, 424, 426, 428, 430, 432, 434, 436, 438) in order to generate at least one monotonous border fragment;
(iv) generating base lines (602, 604, 606, 608, 610) for each of the at least one generated monotonous border fragment in order to have projections to each base line (602, 604, 606, 608, 610) from each border fragment respectively, and storing base lines coordinates;
(v) projecting heights (802) from each of the at least one monotonous border fragment to its respective base line (602, 604, 606, 608, 610), the projecting being executed at a predetermined heights pace, starting from a beginning of a respective monotonous border fragment and finishing at an end of the respective monotonous border fragment;
(vi) calculating heights values, each height value being representative of a distance between the respective base line (602, 604, 606, 608, 610) and a respective point on a respective monotonous border fragment, the heights values for generating heights maps of monotonous border fragments;
(vii) storing data for rendering the monotonous border fragment as an ensemble of:
   the base line coordinates, and
   the heights pace, and
   a sequence of heights values in association with a respective base line (602, 604, 606, 608, 610).

Clause 2. Method of clause 1, wherein steps of (i) measuring plurality of angles between traversing elements (402, 406, 408, 410, 412, 414, 416, 418, 420, 422, 424, 426, 428, 430, 432, 434, 436, 438) and of (ii) splitting the border into border fragments, are performed sequentially and repetitively, before generating base lines (602, 604, 606, 608, 610) for at least one monotonous border fragment.

Clause 3. Method of any one of clauses 1 to 2, wherein generating the border of the graphical object (200) is generating a line.

Clause 4. Method of any one of clauses 1 to 3, wherein applying to the border of the graphical object (200) at least two traversing elements (402, 406, 408, 410, 412, 414, 416, 418, 420, 422, 424, 426, 428, 430, 432, 434, 436, 438) is applying at least two traversing lines (402, 406, 408, 410, 412, 414, 416, 418, 420, 422, 424, 426, 428, 430, 432, 434, 436, 438).

Clause 5. The method of any one of clauses 1 to 4, wherein generating the base line (602, 604, 606, 608, 610) is executed by drawing two parallel lines (6020 and 6022, 6040 and 6042, 6060 and 6062, 6080 and 6082, 6100 and 6102) such that one of the two parallel lines crosses the beginning of the border fragment, and the other parallel line crosses the end of the border fragment, and the base line (602, 604, 606, 608, 610) is generated as an interval connecting these two parallel lines (6020 and 6022, 6040 and 6042, 6060 and 6062, 6080 and 6082, 6100 and 6102) and being perpendicular to both these parallel lines (6020 and 6022, 6040 and 6042, 6060 and 6062, 6080 and 6082, 6100 and 6102).

Clause 6. Method of any one of clauses 1 to 5, wherein the two traversing elements (402, 406, 408, 410, 412, 414, 416, 418, 420, 422, 424, 426, 428, 430, 432, 434, 436, 438), in the step of the splitting the border into border fragments, are consecutive traversing elements, and wherein the method further comprises splitting said border fragments into smaller fragments until each angle between each two non-consecutive traversing elements (402, 406, 408, 410, 412, 414, 416, 418, 420, 422, 424, 426, 428, 430, 432, 434, 436, 438) within a respective smaller fragment is less than the predetermined threshold.

Clause 7. Method of any one of clauses 1 to 6, wherein the heights values are at least one selected from: positive values, zero value, negative values.

Clause 8. Method of any one of clauses 1 to 7, wherein each traversing angle between each traversing element (402, 406, 408, 410, 412, 414, 416, 418, 420, 422, 424, 426, 428, 430, 432, 434, 436, 438) and the border of the graphical object (200) in each respective intersection point (452, 454, 456, 458, 460, 462, 464, 464, 466, 468, 470, 472, 474, 476, 478,480, 482, 484, 486, 488) is 90 degrees.

Clause 9. A computing device (102) for storing data for rendering a graphical object (200), the graphical object (200) having non-monotonous border defined by its conventional coordinates, the computing device (102) comprising a processor (108) and an information storage medium (104) storing instructions that, when executed by the processor (108), cause the processor (108) to execute a method of any one of clauses 1 to 8.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method of storing data for rendering a graphical object, the graphical object having a border being non-monotonous and being defined by conventional coordinates, the method comprising:
(i) based on the conventional coordinates, generating the border of the graphical object;
(ii) applying to the border of the graphical object, at predetermined intervals, at least two traversing elements, each traversing element traversing the border of the graphical object at a respective intersection point under a same traversing angle;
(iii) measuring plurality of angles between traversing elements and, responsive to at least one angle of the plurality of angles between two particular traversing elements exceeding a predetermined threshold, splitting the border into border fragments at points located within a respective interval defined by said particular two traversing elements in order to generate at least one monotonous border fragment;
(iv) generating base lines for each of the at least one generated monotonous border fragment in order to have projections to each base line from each border fragment respectively and storing base lines coordinates;
(v) projecting heights from each of the at least one monotonous border fragment to its respective base line, said projecting being executed at a predetermined heights pace, starting from a beginning of a respective monotonous border fragment and finishing at an end of the respective monotonous border fragment;
(vi) calculating heights values, each height value being representative of a distance between the respective base line and a respective point on a respective monotonous border fragment, the heights values for generating heights maps of monotonous border fragments;
(vii) storing data for rendering the monotonous border fragment as an ensemble of:
the base line coordinates, and
the heights pace, and
a sequence of heights values in association with a respective base line.

2. The method of claim 1, wherein steps of (i) measuring plurality of angles between traversing elements and of (ii) splitting the border into border fragments, are performed sequentially and repetitively, before generating base lines for at least one monotonous border fragment.

3. The method of claim 1, wherein generating the border of the graphical object is generating a line.

4. The method of claim 1, wherein applying to the border of the graphical object at least two traversing elements is applying at least two traversing lines.

5. The method of claim 1, wherein generating the base line is executed by drawing two parallel lines such that one of the two parallel lines crosses the beginning of the border fragment, and the other parallel line crosses the end of the border fragment, and the base line is generated as an interval connecting said two parallel lines and being perpendicular to both said parallel lines.

6. The method of claim 1, wherein the two traversing elements, in the step of the splitting the border into border fragments, are consecutive traversing elements, and wherein the method further comprises splitting said border fragments into smaller fragments until each angle between each two non-consecutive traversing elements within a respective smaller fragment is less than the predetermined threshold.

7. The method of claim 1, wherein the heights values are at least one, selected from:
positive values, zero value, negative values.

8. The method of claim 1, wherein each traversing angle between each traversing element and the border of the graphical object in each respective intersection point is 90 degrees.

9. A computing device for storing data for rendering a graphical object, the graphical object having a border being non-monotonous and being defined by conventional coordinates, the computing device comprising a processor and an information storage medium storing instructions that, when executed by the processor, cause the processor to:
(i) based on conventional coordinates, generate the border of the graphical object;
(ii) apply to the border of the graphical object, at predetermined intervals, at least two traversing elements, each traversing element traversing the border of the graphical object at a respective intersection point under a same traversing angle;
(iii) measure plurality of angles between traversing elements and, responsive to at least one angle of the plurality of angles between two particular traversing elements exceeding a predetermined threshold, split the border into border fragments at points located within a respective interval defined by said particular two traversing elements in order to generate at least one monotonous border fragment;
(iv) generate base lines for each of the at least one generated monotonous border fragment in order to have projections to each base line from each border fragment respectively and store base lines coordinates;
(v) project heights from each of the at least one monotonous border fragment to its respective base line, said projecting being executed at a predetermined heights pace, starting from a beginning of a respective monotonous border fragment and finishing at an end of the respective monotonous border fragment;
(vi) calculate heights values, each height value being representative of a distance between the respective base line and a respective point on a respective monotonous border fragment, the heights values for generating heights maps of monotonous border fragments;
(vii) store data for rendering the monotonous border fragment as an ensemble of:
the base line coordinates, and
the heights pace, and
a sequence of heights values in association with a respective base line.

10. The computing device of claim 9 wherein, before generating base lines for at least one monotonous border fragment, the processor performs steps of (i) measuring plurality of angles between traversing elements and of (ii) splitting the border into border fragments, sequentially and repetitively.

11. The computing device of claim 9, wherein generating the border of the graphical object is generating a line.

12. The computing device of claim 9, wherein applying to the border of the graphical object at least two traversing elements is applying at least two traversing lines.

13. The computing device of claim 9, wherein the processor generates the base line by drawing two parallel lines such that one of the two parallel lines crosses the beginning of the border fragment, and the other parallel line crosses the end of the border fragment, and the processor generates the base line as an interval connecting said two parallel lines and being perpendicular to both said parallel lines.

14. The computing device of claim 9, wherein the two traversing elements, in the step of the splitting the border into border fragments, are consecutive traversing elements, and wherein the instructions that, when executed by the processor, further cause the processor to split said border fragments into smaller fragments until each angle between each two non-consecutive traversing elements within a respective smaller fragment is less than the predetermined threshold.

15. The computing device of claim 9, wherein the heights values are at least one selected from: positive values, zero value, negative values.

16. The computing device of claim 9, wherein each traversing angle between each traversing element and the border of the graphical object in each respective intersection point is 90 degree.
